(19) United States
(12) Patent Application Publication
(10) Pub. No.: US 2003/0004741 A1
(43) Pub. Date: Jan. 2, 2003

(54) Integrated vehicle service and warranty information delivery device and method

(76) Inventors: Lester Benjamin Johnson, Kalamazoo, MI (US); Frank L. Newton, Lawton, MI (US)

Correspondence Address: BAKER & HOSTETLER LLP, Washington Square, Suite 1100, 1050 Connecticut Avenue, N.W., Washington, DC, 20036, US

(21) Appl. No.: 10/028,722

(22) Filed: Dec. 28, 2001

Related U.S. Application Data
(60) Provisional application No. 60/258,549, filed on Dec. 29, 2000.
(60) Provisional application No. 60/258,903, filed on Dec. 29, 2000.
(60) Provisional application No. 60/258,550, filed on Dec. 29, 2000.

(51) Int. Cl. G06F 17/60

(52) U.S. Cl. 705/1

(57) ABSTRACT

An improved system and method is disclosed for providing vehicle service and warranty information to service technicians.

### PRIORITY CLAIM

This application claims priority to provisional U.S. Patent Applications entitled, Integrated Vehicle Service Information Delivery Device and Method, filed Dec. 29, 2000, having serial No. 60/258,549, Integrated Vehicle Warranty Information Delivery Device and Method, filed Dec. 29, 2000, having serial No. 60/258,903, and Online Integrated Vehicle Information Delivery Device and Method, filed Dec. 29, 2000, having serial No. 60/258,550, the disclosures of which are incorporated herein by reference.

### FIELD OF THE INVENTION

The present invention relates generally to methods and systems for assisting vehicle repair personnel with vehicle repairs. In particular, the present invention relates to methods and systems for providing vehicle-specific service information to persons who desire to perform vehicle repairs.

### BACKGROUND OF THE INVENTION

The repair of automobiles, trucks, motorcycles, and other vehicles requires a vast array of information relating to the specific vehicle that is being serviced. Vehicle service technicians must be able to recognize problems in any number of vehicles, despite the fact that there are design differences between vehicle manufacturers, between models produced by an individual manufacturer, or even between various years of the same model vehicle.

Because it is impossible for any individual to be familiar with all aspects of every vehicle that may come into a vehicle repair shop, the technician must rely on reference materials, such as bound volumes of service bulletins, product recall brochures, warranty information sheets, and design manuals to diagnose and repair a potential problem with a vehicle.

Because there is so much service information available for so many vehicles, the process of searching for relevant literature to help diagnose and repair a vehicle problem can be very time-consuming. Previously, entities that provide service repair information have attempted to solve this problem by providing the information in electronic form, such as a CD-ROM, and allowing the user of the CD-ROM to perform keyword searches of the text contained in the CD-ROM.

However, the prior art attempts to solve the above problems exhibit several disadvantages. For example, the available CD-ROM vehicle service information compilations require that the technician subjectively select a keyword and enter the keyword into a search interface. The results of the search then typically include any and all items on the CD-ROM that contain the keyword or keywords entered by the user. These methods and systems produce irrelevant information which the user must wade through in the hope that relevant information will be found. In addition, these methods and systems can yield unsatisfactory results if the document contained on the CD-ROM uses terminology that differs from the keyword or keywords entered by the user. In addition, these methods and systems do not automatically alert the user if a vehicle abnormality is covered by a manufacturer's or dealer's warranty.

Therefore, we have determined that it is desirable to provide an improved method and system for delivering vehicle service and/or warranty information to assist persons servicing a vehicle.

The present invention is directed to solving one or more of the problems described above.

### SUMMARY OF THE INVENTION

The above and other features and advantages are achieved through the use of a novel vehicle service information delivery method and system as herein disclosed.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a flowchart representing a process performed in accordance with a preferred embodiment of the present invention.

FIG. 2 is a system in accordance with a preferred embodiment of the present invention.

FIG. 3 is a block diagram representation of the system of FIG. 2.

### DETAILED DESCRIPTION OF PREFERRED EMBODIMENTS OF THE INVENTION

In accordance with one embodiment of the present invention, one or more items of vehicle diagnostic equipment, such as equipment using the method disclosed in columns 3-9 and the accompanying drawings of U.S. Pat. No. 5,631,831 to Bird et al., which is incorporated herein by reference, and/or onboard monitoring equipment may be connected to a vehicle. The equipment items receive inputs corresponding to the operation of the vehicle, such as, for example, amps and volts corresponding to inputs to or outputs from various engine parts, emission gas analyses, and other data. Further examples are provided in the application entitled Global Signaling Memory, application Ser. No. 09/841,857, filed Apr. 25, 2001, the disclosure of which is incorporated herein by reference.

In addition or in the alternative, one or more onboard monitoring systems may be connected to or included with the vehicle. The diagnostic equipment and/or onboard monitoring systems are communicative with one or more computing devices having a processor, a memory, and a means for presenting information to a user via audio and/or video. The diagnostic equipment and computing devices may be directly connected or may be separate but communicative via direct wiring, a network, telephone or cable lines, wireless communication means, or other communication means using communications protocols such as TCP/IP.

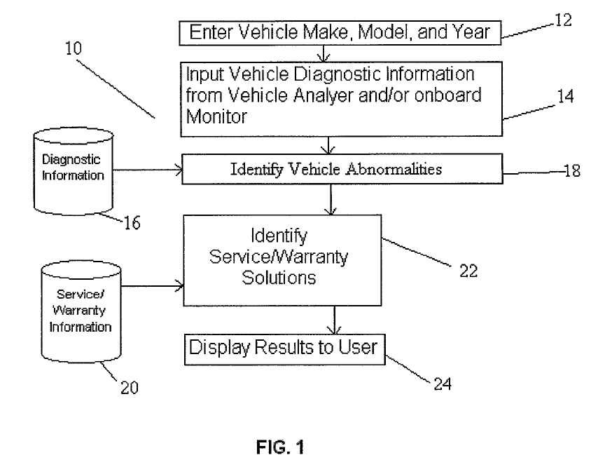

FIG. 1 illustrates the steps of an exemplary method 10 using a device configuration such as that described above. Referring to FIG. 1, a user enters data corresponding to the make, model, and year of manufacture of a vehicle into an input of a computing device 12. The output data points of one or more items of vehicle diagnostic and/or onboard monitoring equipment are also entered into the computing device 14. As noted above, the input may be directly received from the diagnostic equipment or indirectly via a communication means using a communication protocol such as TCP/IP.

The computing device maintains a database of vehicles and anticipated diagnostic and/or monitoring information corresponding to vehicles 16. The processor compares the information received from the equipment and compares such information with the data in the database to identify abnormalities 18. If one or more abnormalities are identified, the processor accesses a database 20 containing service information, such as technical service bulletins, design and service manuals, product recalls, and other information.

Optionally, the database may also contain information corresponding to product warranties, and the processor may identify whether the proposed solution is covered by the applicable warranty. The service information database may be separate from the diagnostic and monitoring information database, or it may optionally be integral with the diagnostic and monitoring information database. The processor compares the abnormality or abnormalities with the relevant service and/or warranty information contained in the database for the vehicle and presents the results to the user 22. The presentation 24 may be via any appropriate means, such as a computer display, an audio and/or video presentation, and/or a printed report. Optionally, the presentation may be implemented directly by the computing device, or the information may be communicated to the user by a wired or wireless communication means using a communications protocol such as TCP/IP.

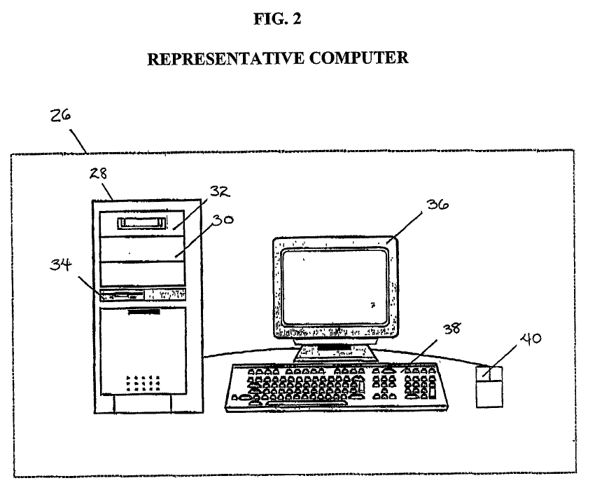

FIG. 2 illustrates a computer of a type suitable for carrying out and/or comprising the system of the invention. Viewed externally in FIG. 2, a computer system designated by reference numeral 26 has a central processing unit located within a housing 28 and disk drives 30, 32 and 34. Disk drives 30, 32 and 34 are merely symbolic of a number of disk drives which might be accommodated by the computer system. Typically these would include a hard disk drive and optionally one or more floppy disk drives such as 34 and/or one or more CD-ROMs, CD-Rs, CD-RWs or digital video disk (DVD) devices indicated by slot 30. The number and types of drives typically varies with different computer configurations. Disk drives 30, 32 and 34 are in fact options, and they may be omitted from the computer system used in connection with the processes described herein. Additionally, the computer system utilized for implementing the present invention may be a stand-alone computer having communications capability, a computer connected to a network or able to communicate via a network, a handheld computing device, or any other form of computing device capable of carrying out equivalent operations.

The computer also has or is connected to or delivers signals to a display 36 upon which graphical, video and/or alphanumeric information is displayed. The display may be any device capable of presenting visual images, such as a television screen, a computer monitor, a projection device, a handheld or other microelectronic device having video display capabilities, or even a device such as a headset or helmet worn by the user to present visual images to the user's eyes. The computer may also have or be connected to other means of obtaining signals to be processed. Such means of obtaining these signals may include any device capable of receiving images and image streams, such as video input and graphics cards, digital signal processing units, appropriately configured network connections, or any other microelectronic device having such input capabilities.

An optional keyboard 38 and a directing device 40 such as a remote control, mouse, joystick, touch pad, track ball, steering wheel, remote control or any other type of pointing or directing device may be provided as input devices to interface with the central processing unit.

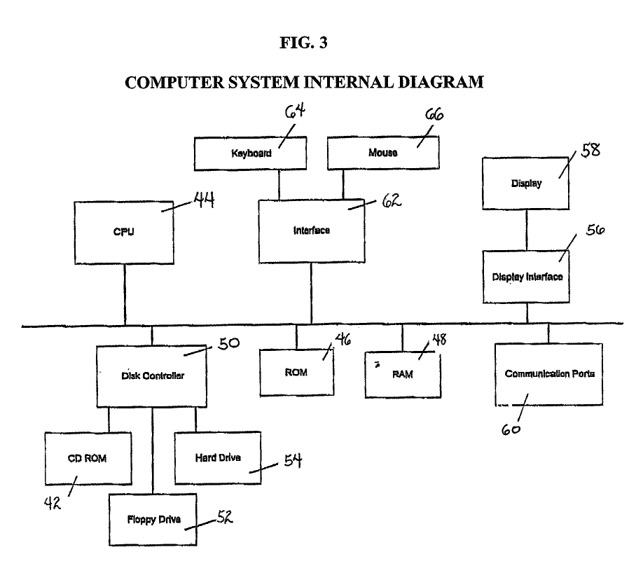

FIG. 3 illustrates a block diagram of the internal hardware of the computer of FIG. 2. A bus 42 serves as the main information highway interconnecting the other components of the computer. CPU 44 is the central processing unit of the system, performing calculations and logic operations required to execute a program. Read only memory (ROM) 46 and random access memory (RAM) 48 constitute the main memory of the computer.

A disk controller 50 interfaces one or more disk drives to the system bus 42. These disk drives may be external or internal floppy disk drives such as 52, external or internal CD-ROM, CD-R, CD-RW or DVD drives such as 42, or external or internal hard drives 54. As indicated previously, these various disk drives and disk controllers are optional devices.

Program instructions may be stored in the ROM 46 and/or the RAM 48. Optionally, program instructions may be stored on a computer readable carrier such as a floppy disk or a digital disk or other recording medium, a communications signal, or a carrier wave.

A display interface 56 permits information from the bus 42 to be displayed on the display 58 in audio, graphic or alphanumeric format. Communication with external devices may optionally occur using various communication ports such as 60.

In addition to the standard components of the computer, the computer also includes an interface 62 which allows for data input through the keyboard 64 or other input device and/or the directional or pointing device 66 such as a remote control, pointer, mouse or joystick.

The many features and advantages of the invention are apparent from the detailed specification, and thus, it is intended by the appended claims to cover all such features and advantages of the invention which fall within the true spirits and cope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

The many features and advantages of the invention are apparent from the detailed specification, and thus, it is intended by the appended claims to cover all such features and advantages of the invention which fall within the true spirits and cope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method for providing vehicle information, comprising the steps of:
entering vehicle identification information into a system;
entering vehicle diagnostic information into the system;
comparing the entered vehicle diagnostic information with reference diagnostic information located using the entered vehicle identification information; and
displaying data as a result of the comparison.

2. The method of claim 1 further comprising the step of identifying service solutions as a result of the comparison and wherein the data displayed includes the service solutions.

3. The method of claim 1 further comprising the step of identifying warranty solutions as a result of the comparison and wherein the data displayed includes the warranty information.

4. The method of claim 3 further comprising the step of identifying service solutions as a result of the comparison and wherein the data displayed includes the service solutions.

5. The method of claim 4 wherein the vehicle identifying data includes the make, model and year of the vehicle.

6. A system for providing vehicle information, comprising:
means for entering vehicle identification information into the system;
means for entering vehicle diagnostic information into the system;
means for comparing the entered vehicle diagnostic information with reference diagnostic information located using the entered vehicle identification information; and
means for displaying data as a result of the comparison.

7. The system of claim 6 further comprising the means for identifying service solutions as a result of the comparison and wherein the data displayed includes the service solutions.

8. The system of claim 6 further comprising means for identifying warranty solutions as a result of the comparison and wherein the data displayed includes the warranty information.

9. The system of claim 8 further comprising means for identifying service solutions as a result of the comparison and wherein the data displayed includes the service solutions.

10. The system of claim 9 wherein the vehicle identifying data includes the make, model and year of the vehicle.

11. A system for providing vehicle information, comprising:
a database of vehicle diagnostic information searchable by vehicle identifying data;
a data input wherein vehicle diagnostic data is input to the system through the data input;
a database of service related vehicle information; and
a microprocessor that compares the diagnostic data received at the data input with reference diagnostic information from the database and outputs service related vehicle data as a result of the comparison.

12. The system of claim 11 wherein the service related vehicle information includes repair data.

13. The system of claim 11 wherein the service related vehicle information includes warranty information.

14. The system of claim 13 wherein the service related vehicle information includes repair information.

15. The system of claim 11 wherein the vehicle identifying data includes vehicle make, model and year of the vehicle.

16. The system of claim 11 wherein the vehicle diagnostic data is input to the system over a wireless communications link.

17. The system of claim 16 wherein the vehicle identifying data is input to the system over a wireless communications link.

18. The system of claim 11 wherein the vehicle diagnostic data is input to the system using the TCP/IP protocol.

19. The system of claim 18 wherein the vehicle identifying data is input to the system using the TCP/IP protocol.
